(19) United States
(12) Patent Application Publication
(10) Pub. No.: US 2004/0222323 A1
(43) Pub. Date: Nov. 11, 2004

(54) Nozzle device and substrate treating apparatus having using the device

(75) Inventors: Takeshi Akasaka, Amagasaki-shi (JP); Shigeru Mizukawa, Amagasaki-shi (JP); Takashi Murata, Amagasaki-shi (JP); Katsutoshi Nakata, Amagasaki-shi (JP); Shunji Matsumoto, Amagasaki-shi (JP)

Correspondence Address: DARBY & DARBY P.C., P. O. BOX 5257, NEW YORK, NY, 10150-5257, US

(73) Assignee: Sumitomo Precision Products Co., Ltd., Amagasaki-shi (JP)

(21) Appl. No.: 10/860,927

(22) Filed: Jun. 3, 2004

Related U.S. Application Data
(63) Continuation of application No. PCT/JP01/11056, filed on Dec. 17, 2001.

(30) Foreign Application Priority Data
Dec. 17, 2001 (JP) 2001-377100

(51) Int. Cl. B01D 1/00

(52) U.S. Cl. 239/565

(57) ABSTRACT

A nozzle device forms a treatment film with a uniform thickness on a substrate with a small amount of treatment liquid and a substrate treatment device. A nozzle device 10 includes a plurality of discharge ports 18 formed on the bottom, a liquid retaining chamber 22 for retaining supplied treatment liquid, and a liquid discharge paths 23 and 17 that communicate with each discharge port 18 on one end and communicate with the retaining chamber 22 on the other end. The paths allow the treatment liquid retained in the liquid retaining chamber 22 to flow to the discharge ports 18 where the liquid is discharged. The discharge ports 18 are arranged in double rows along a longitudinal direction of the nozzle device 10. The discharge ports of one row is staggered with respect to the discharge ports of the other row so that the discharge ports 18 form a staggered pattern in the arranged direction.

### CROSS-REFERENCE TO RELATED APPLICATION

This application is a Continuation of International Patent Application Serial No. PCT/JP01/11056 filed Dec. 17, 2001, which was published in Japanese on Jun. 19, 2003 as WO 03/049868 A1, and which is incorporated herein by reference in its entirety.

### TECHNICAL FIELD OF THE INVENTION

The present invention relates to a nozzle device for discharging on substrates such as liquid crystal glass substrate, semiconductor wafers (silicon wafers), photomask glass substrates, optical disc substrates, and the like and coating them with treatment liquids such as chemicals and detergents, and a substrate treatment device equipped therewith.

### BACKGROUND OF THE INVENTION

A glass substrate that constitutes a liquid crystal substrate is manufactured through various steps of process, and the glass substrate is coated in those steps with various treatment liquids, e.g., a resist material, a developing liquid, its removing chemical, a washing liquid, etc.

The coating of the glass substrate with a treatment liquid has been traditionally done by a substrate treatment device comprising a supporting mechanism that supports the glass substrate horizontally, a nozzle device that discharges a treatment liquid onto the glass substrate held horizontally, and a transport device that is located above and transports (for scanning) the nozzle device along it. A typical design of said nozzle device is shown in FIG. 12 and FIG. 13.

Said nozzle device 100 comprises, as shown in FIG. 12 and FIG. 13, a long nozzle body 101 provided above and along the width direction of glass substrate W (a direction perpendicular to the paper surface in FIG. 12 which is the direction indicated by an arrow H in FIG. 13), and a bracket 108 affixed to nozzle body 101 and connected to an appropriate supporting part of said transport device of said transport device.

Nozzle body 101 comprises a long first member 102 and a second member 106, and those first member 102 and second member 106 are jointed together across a sealing gasket 107, thus forming an intended structure. First member 102 has a groove 103 opening on one side along its longitudinal direction, which opening is closed by jointed second member 106 to form a supply chamber 103.

First member 102 is also provided with a supply port 104 which opens at the top of the first member and communicates on the other side with said supply chamber 103. Supply port 104 is connected via a pipe fitting 112 with a supply pipe 111, which connects to a treatment liquid supply device 110 on the other end, so that the treatment liquid is supplied from treatment liquid supply device 110 to said supply chamber 103 via supply pipe 111 and supply port 104.

Said first member 102 are provided with discharge ports 105 that open to its bottom surface and said supply chamber 103 formed in a row with a specified pitch (interval) along the lengthwise direction of first member 102, so that the treatment liquid supplied to said supply chamber 103 flows through these discharge ports 105 and is discharged through the openings onto the substrate W to coat it.

Nozzle device 100 with such a structure has its bracket 108 connected to an appropriate supporting part of said transport device to be supported by the transport device and is transported (for scanning) by the transport device in a direction perpendicular to the width direction (direction of arrow H) of the glass substrate W.

The substrate treatment device having said structure supplies the pressurized treatment liquid from treatment liquid supply device 110 to nozzle device 100 and discharges the liquid from the openings of said discharge ports 105.

The treatment liquid discharged from said discharge ports 105 each becomes a line of liquid, thus forming a screen-like flow as a whole, and coats the glass substrate W. When nozzle device 100 is transported in the direction perpendicular to the width direction (direction of arrow H) of the glass substrate W by means of said transport device, the treatment liquid laid on the glass substrate W first forms streaking pools of the liquid extending in the transport direction of nozzle device 100, each of which will then mix with the adjacent streaking pools because of the surface tension of the liquid, finally forming a treatment liquid coat of a specified thickness.

The glass substrate W is coated with a treatment liquid and is treated with it in such a manner in a typical substrate treatment device of prior art.

In the meanwhile, the substrate W such as the glass substrate is getting larger and larger every year. Thus, a need for evenly coating the entire surface of the substrate W is heightening, especially, for coating it with a minimum amount of treatment liquid to form a coating of the treatment liquid with a uniform film thickness on the substrate W.

In order to accomplish it, it seems necessary to minimize the diameter of discharge ports 105 of nozzle device 100 and minimize the port layout pitch in the abovementioned example of prior art, but the discharge ports 105 of nozzle device 100 of prior art are arranged in a single row, so that simply narrowing the port layout pitch would cause the adjacent streams of the liquid discharged from discharging ports to become too close with each other thus causing them to entangle with each other, not only causing them to flow down together in belt-like flows, but also causing these belts to narrow toward the end due to surface tension, thus making it impossible to coat the entire width of the substrate W, and also causing the resultant coating of the treatment liquid film thicker rather than thinner. On the other hand, if the port layout pitch is made wider so that no adjacent flows entangle with each other, the liquid pools R formed on the substrate W remain independent as shown in FIG. 14 as the amount of the treatment liquid discharged from each discharge port is too little, thus making it impossible to form an adequate film of the treatment liquid on the substrate W.

Moreover, since supply port 104, supply chamber 103 and discharge port 105 are provided in that order from the top end to the bottom end of nozzle body 101 in case of said nozzle device 100, the treatment liquid drips down from discharge ports 105 onto the substrate W even after the supply of the treatment liquid from treatment liquid supply device 110 is stopped in terminating the treatment liquid coating process due to the fact that the weight of the treatment liquid in supply chamber 103 acts on the treatment liquid in discharge ports 105. This dripping of the liquid hence causes unevenness of the film thickness of the treatment liquid coated on the substrate W.

The present invention was made under such circumstances and intends to provide a nozzle device that is capable of forming a treatment liquid film with a uniform thickness using a minimum amount of the treatment liquid and a substrate treatment device equipped with such a nozzle device.

### SUMMARY OF THE INVENTION

The present invention for achieving the object stated above is a nozzle device having a long nozzle body for a coating object to be treated with a treatment liquid discharged from said nozzle body, and a substrate treatment device equipped with said nozzle device, wherein

said nozzle body comprising a plurality of discharge ports formed on its bottom surface; a liquid retaining chamber for retaining the supplied treatment liquid, and a liquid discharge flow path which communicates on one end with said discharge ports and on another end with said liquid retaining chamber, causing the treatment liquid retained in said liquid retaining chamber to flow to said discharge ports and to be discharged from said discharge ports; and

said discharge ports being arranged in two rows along the longitudinal direction of said nozzle body with each discharge port of each row arranged between two adjacent ports of the other row, thus forming a staggered pattern of the discharge ports in the arrangement direction.

The nozzle device is provided above the substrate, which is supported by a supporting means, and is transported in the direction perpendicular to the longitudinal direction of the nozzle body along said substrate by a transport means, while the pressurized treatment liquid is supplied to the nozzle body from the treatment liquid supply means.

While the substrate to be treated is held in a horizontal position, the pressurized treatment liquid is supplied to the nozzle device by the treatment liquid supply means, flows into a liquid retaining chamber of the nozzle body, and is discharged after flowing through the liquid discharge flow path from the discharge ports arranged in double rows.

The treatment liquid discharged from said discharge ports each becomes a line of liquid, thus forming a screen-like downward flow as a whole, and coats the substrate. When the nozzle body is transported by said transport means in a direction perpendicular to its lengthwise direction, the treatment liquid that flows down from said discharge ports forms on the substrate streaking pools of the liquid extending in the transport direction of nozzle body.

As said discharge ports of the nozzle device according to the present invention are arranged to form two rows along the longitudinal direction of said nozzle body with discharge ports of each row arranged between two adjacent ports of the other row, thus forming a staggered pattern of the discharge ports in the arrangement direction, the port layout pitch of the discharge ports in the longitudinal direction of the nozzle member can be further reduced, thus causing the adjacent streaking liquid pools extremely closer and allowing them to contact with each other. This makes it possible to cause adjacent streaking liquid pools mix with each other due to the surface tension, thus forming a uniform treatment liquid film with a specified film thickness.

As the discharge ports are arranged in two rows and also in a staggered pattern, it is possible in the nozzle device of the present invention to make the port layout pitch of the entire discharge ports finer without having to make the port layout pitch of the discharge ports of each row too close and to form a treatment liquid film with a uniform film thickness on the substrate with a minimum amount of the treatment liquid using discharge ports with smaller opening.

Thus, the nozzle device and the substrate treatment device according to the present invention can prevent the liquid flows from the discharge ports from contacting and mixing with each other while they are flowing down and flow down as belts of liquid when the port layout pitch is made narrower as in the case of the nozzle device of prior art wherein the discharge ports are arranged in a single row.

There is a concern that, if the liquid retaining chamber and the liquid discharge path are arranged in a vertical row with each other, the treatment liquid drips down from discharge ports even after the supply of the treatment liquid from the treatment liquid supply means is stopped due to the fact that the weight of the treatment liquid in supply chamber acts on the treatment liquid in discharge ports, causing thickness variations in the treatment film formed on the substrate as in the nozzle device of prior art.

In order to eliminate such a problem, it is preferable to arrange the liquid retaining chamber and the liquid discharge path in parallel along the longitudinal direction, provide the top end of the liquid discharge path to be higher than the top edge of the liquid retaining chamber, and connect the top edge of the liquid retaining chamber and the top end of the liquid discharge path with a communicating path.

With such an arrangement, it is possible to have the treatment liquid to flow from the liquid retaining chamber to the liquid discharge path to cause it to be discharged from the discharge ports as the treatment liquid pressure in the liquid retaining chamber is higher than the treatment liquid pressure in the liquid discharge path while the treatment liquid is being supplied from the treatment liquid supply means, and to retain the treatment liquid inside the liquid discharge path by means of its own surface tension when the supply of the treatment liquid is stopped. Thus, the dripping of the treatment liquid from said discharge ports can be prevented by such a constitution.

Moreover, the same constitution allows us to have said liquid discharge flow paths to be formed of a plurality of vertical holes each of which communicates with each discharge port independently, and to have the top end of said vertical hole and the top edge of said liquid retaining chamber to be connected with said communicating path. It can also be constituted in such a way as to comprise a plurality of vertical holes that communicate with said discharge ports individually and a liquid supply chamber formed above said vertical holes in such a way that the bottom edge of said chamber communicate with the top end of said vertical holes, wherein the top edge of said liquid supply chamber is communicating with the top edge of said liquid retaining chamber with said communicating path. However, it is important that the capacity of the liquid supply chamber to be such that the treatment liquid in each vertical hole is to remain in the particular vertical hole by its own surface tension from the standpoint of preventing the liquid drippings.

It is also preferable to keep the opening of each discharge port to be greater than 0.35 mm and less than 5 mm and the port layout pitch of each row to be greater than 1 mm and less than 10 mm.

Moreover, said supporting means and transport means can be constituted with a roller transport device having a plurality of rollers for supporting said substrate and linearly transporting said substrate by means of the rotations of said rollers.

Alternatively, they can be constituted in such a way that said supporting means consists of a carriage on which the substrate is placed, and said transport means linearly transports said nozzle body along said substrate. In this case, a turning device can be provided for horizontally turning said carriage. According to this substrate treatment device, it is possible to form a treatment film with a more uniform thickness by means of thinning the treatment liquid coated on the substrate by means of centrifugal force generated by horizontally turning the substrate using said turning device after coating the substrate with the treatment liquid with the nozzle device.

The present invention can be applied without any restrictions to various substrates including liquid crystal glass substrates, semiconductor wafers (silicon wafers), photomask glass substrates, and optical disk substrates. Moreover, there is no particular restriction to the treatment liquid to which this invention can be applied and the applicable treatment liquids include various treatment liquids used in the manufacturing process of semiconductors and liquid crystals such as developing liquid, resist liquid, resist removing liquid, etching liquid, and washing liquids (pure water, ozone water, hydrogen water, electrolytic water, etc.)

### BRIEF DESCRIPTION OF THE DRAWINGS

FIG. 1 is a cross-sectional plan view (a cross-sectional plan view in the direction of arrows II-Il in FIG. 2) of a substrate treatment device according to an embodiment of the present invention.

FIG. 2 is a cross-sectional side view in the direction of arrows I-I in FIG. 1.

FIG. 3 is a cross-sectional front view (a cross-sectional front view in the direction of arrows IV-IV in FIG. 5) of a nozzle device according to an embodiment of the present invention.

FIG. 4 is a bottom view of the nozzle device shown in FIG. 3.

FIG. 5 is a cross-sectional side view in the direction of arrows III-III in FIG. 3.

FIG. 6 is a descriptive drawing for describing the treatment liquid coating action of the nozzle device according an embodiment of the present invention.

FIG. 7 is a descriptive drawing for describing the treatment liquid coating action of the nozzle device according to an embodiment of the present invention.

FIG. 8 is a cross-sectional front view (a cross-sectional front view in the direction of arrows VI-VI in FIG. 9) of a nozzle device according to another embodiment of the present invention.

FIG. 9 is a cross-sectional side view in the direction of arrows V-V in FIG. 8.

FIG. 10 is a cross-sectional front view of a substrate treatment device according to another embodiment of the present invention.

FIG. 11 is a plan view of the substrate treatment device shown in FIG. 10.

FIG. 12 is a cross-sectional side view of a nozzle device of prior art.

FIG. 13 is a bottom view of the nozzle device shown in FIG. 12.

FIG. 14 is a descriptive drawing for describing a nozzle device of prior art.

### DETAILED DESCRIPTION OF THE INVENTION

A detailed description of the present invention referring to the accompanying drawings is provided in the following for further understanding of the invention.

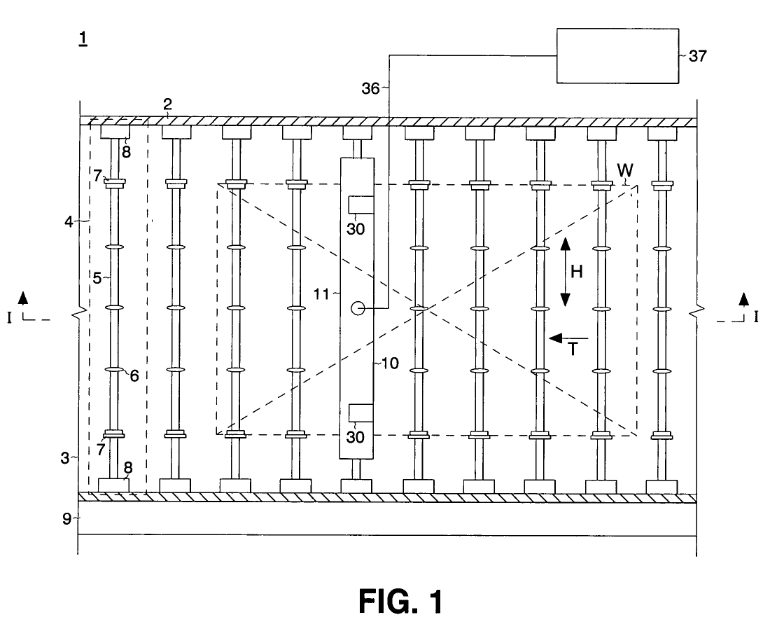

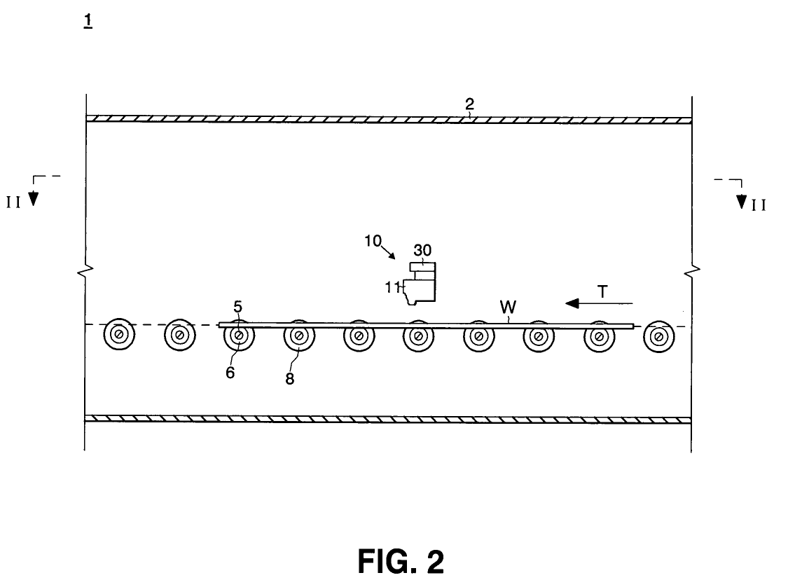

FIG. 1 and FIG. 2 shows a substrate treatment device 1 according to the present invention comprising a cover 2 that forms a closed space, a plurality of transfer rollers 4 provided with a specific interval in said closed space, a transport device 3 for transporting the substrate W to be treated while supporting it with said transport rollers 4, a nozzle device 10 for discharging a treatment liquid onto said substrate W to coat it, and a treatment liquid supply device 37 for supplying the pressurized treatment liquid to nozzle device 10.

In addition to transport rollers 4 mentioned in the above, transport device 3 has bearings 8 that support the rollers free to rotate, and a drive mechanism 9 that drives each transport roller 4. Each transport roller 4 consists of a rotating shaft 5, which is supported to rotate freely on both ends by said bearings 8, and rollers 6 and 7, which are affixed on rotating shaft 5 with a specified interval along its longitudinal direction, wherein rollers 7 on both ends in the axial direction of rotating shaft 5 each has a flange, which guides the substrate W transported by rollers 6 and 7 from derailing out of the transport path.

Although it is not shown in the drawings, said drive mechanism 9 comprises a drive motor and a drive belt that transmits the drive force of said motor to each rotating shaft 5, and rotates rotating shaft 5 in the direction of transporting the substrate W in the direction of the arrow T.

Nozzle device 10 comprises a long nozzle body 11 provided along the width direction (direction indicated by an arrow H) of the substrate W as shown in FIG. 1, and brackets 30, which are mounted on nozzle member 11 and are connected to a proper structural member (not shown).

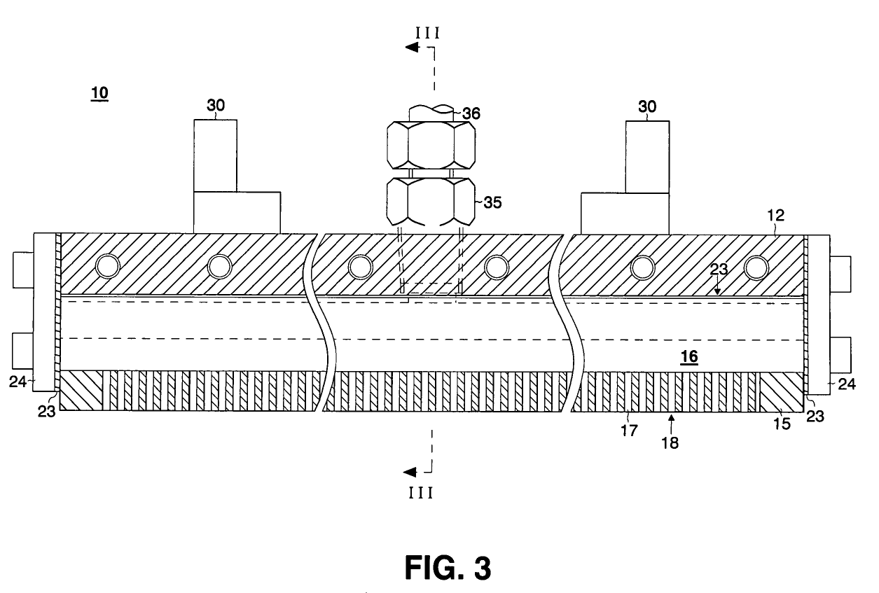

Nozzle body 11 comprises a long first member 12 and a second member 15, and first member 12 and second member 15 are jointed together across a sealing gasket 20 and 21, thus forming an intended structure as shown in FIG. 3 and FIG. 5. First member 12 and second member 15 are formed in hook-like shapes in cross-sectional views having horizontal sides of 12b and 15b as well as vertical sides of 12a and 15a, wherein the ends of horizontal side 12b of first member 12 and vertical side of 15a of second member 15 are joined together across gasket 20 while the ends of vertical side 12a of first member 12 and horizontal side of 15b of second member 15 are joined together across gaskets 21.

Also, a groove 13 is formed in said longitudinal direction in the corner where the bottom surface of horizontal side 12b and the end surface of vertical side of 12a of first member 12 cross each other, and a groove 19 is formed in said longitudinal direction in the corner where the top surface of horizontal side 15b and the end surface of vertical side of 15a of second member 15 cross each other, so that groves 13 and 19 form a liquid retaining chamber 22 when first member 12 and second member 15 are united as described above.

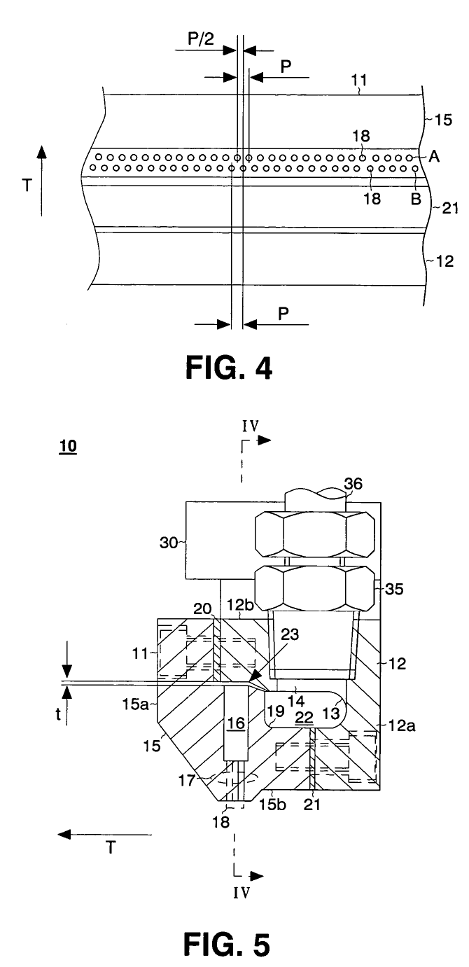

Also, a groove-like liquid supply chamber 16 that opens to the top surface of horizontal side 15b of second member 15 is provided in parallel to said liquid retaining chamber 22 along said longitudinal direction, and a plurality of vertical holes 17 are provided that open to the bottom surface of said liquid supply chamber 16 on one side and open to the bottom surface of said horizontal side 15b as discharge ports 18 on the other side. Vertical holes 17 are arranged in two rows (row A and row B) in the longitudinal direction of second member 15 as shown in FIG. 4. The discharge ports 18 of each row are arranged with the same port layout pitch P, and discharge ports 18 of each adjacent row are aligned with the center of the two adjacent ports in the other row, so that the discharge ports 18 form a staggered pattern in the arrangement direction as a whole. Assuming that the diameter of discharge port 18 is d, layout pitch P is preferably P≦2d.

First member 12 and second member 15 are jointed together in such a way that a clearance of a specified height (dimension t) is to be formed between the bottom surface of horizontal side 12b of first member 12 and the top surface of horizontal side 15b of second member 15 and this clearance serves as a communicating path 23 that communicates between said liquid retaining chamber 22 and liquid supply chamber 16. Also, as shown in FIG. 5, the top edge of liquid supply chamber 16 is located above the top edge of liquid retaining chamber 22.

Also, as shown in FIG. 3, a jointing member 24 is affixed on each end of first member 12 and second member 15 via a gasket 23, and the treatment liquid flow path consisting of liquid retaining chamber 22, communicating path 23, and liquid supply chamber 16 is sealed by gaskets 20, 21, and 23.

As shown in FIG. 3 and FIG. 5, a supply port 14 is formed in substantially middle of the longitudinal direction of first member 12 opening on its top surface as well as on liquid retaining chamber 22, and a supply pipe 36 connecting to treatment supply device 37 is connected to supply port 14 via a pipe fitting 35, so that the pressurized treatment liquid is supplied from treatment liquid supply device 37 to liquid retaining chamber 22 via supply pipe 36 and supply port 14.

According to substrate treatment device 1 of this embodiment with said constitution, when the substrate W being transported in the direction of arrow T by transport device 3 reaches its specified position, treatment supply device 37 starts to supply the treatment liquid and the pressurized treatment liquid is supplied by treatment liquid supply device 37 through supply pipe 36 to nozzle body 11. After reaching liquid retaining chamber 22 through supply port 14, the treatment liquid supplied to nozzle body 11 flows through communicating path 23, liquid supply chamber 16, and each vertical hole 17 to be discharged from each discharge port 18 provided in two rows, row A and row B, to form a line of liquid flow respectively, and forming as a whole a screen-like flow.

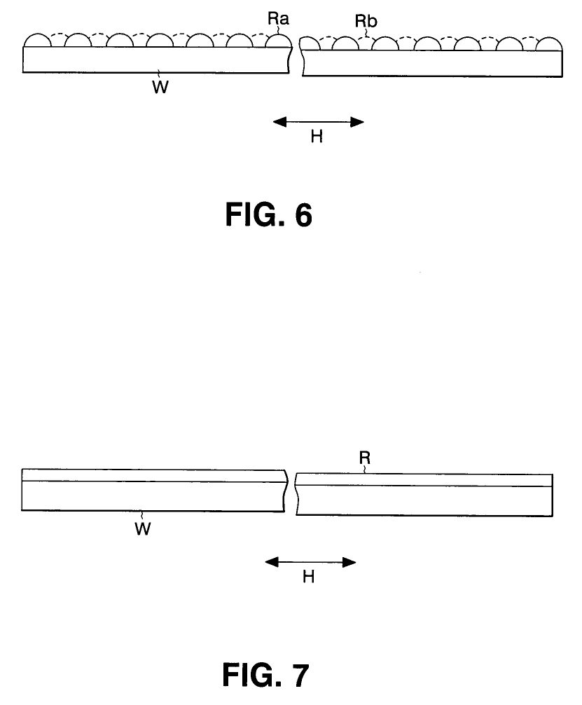

On the other hand, since the substrate W is being transported simultaneously in the direction of arrow T under nozzle body 11 by means of transporting device 3, thus causing the treatment liquid that is flowing as lines of flow from nozzle body 11 to form a streaking lines of liquid pool on the substrate W extending in the direction of trans port of the substrate W. More specifically, the streams flowing down from discharge ports 18 of row A, which are located on the downstream side in the transport direction (direction indicated by arrow T) of the substrate W, are laid first on the substrate W, immediately followed by the streams flowing down from discharge ports 18 of row B, which are located on the upstream side are laid next on the substrate W. This condition is shown in FIG. 6. In FIG. 6, liquid pools Ra created by the flows from the discharge ports 18 of row A are indicated by solid lines and liquid pools Rb created by the flows from the discharge ports 18 of row B are indicated by dotted lines.

If the port layout pitch P is selected as P≦2d, treatment liquid Ra flowing out of discharge ports 18 of row A and treatment liquid Rb flowing out of discharge ports 18 of row B overlap each other and mixed together on the substrate W as shown in FIG. 6 and the treatment liquid spreads out thinly on the substrate W because of its surface tension, thus forming a treatment liquid film R with a uniform specified film thickness on the substrate W as shown in FIG. 7.

As mentioned before, the size of the substrate W such as the glass substrate is increasing year after year, so that a technology for forming a film of the treatment liquid with a uniform film thickness on the substrate W with a minimum amount of treatment liquid is keenly sought in order to minimize the treatment cost. To accomplish it, it is necessary to minimize the diameter of discharge port 18 and to minimize the port layout pitch P.

However, as already mentioned, if the port layout pitch is chosen to be too close in a typical device of prior art, the distances between the adjacent flows discharged from the discharge ports become too close as the discharge ports are arranged in a single row, thus causing the adjacent flows join and mix to form a belt-like flows, so that they fail to cover the entire width of the substrate and the film thickness becomes thicker rather than thinner. On the other hand, if the port layout pitch is chosen too coarse, the liquid pools laid out on the substrate remain independent of each other without mingling as the treatment liquid amount from each discharge port is too little, thus failing to form a film of the treatment liquid.

On the other hand, in the case of substrate treatment device 1 of this embodiment, discharge ports 18 are arranged in two rows along the lengthwise direction of nozzle body 11, and the discharge ports 18 of each row are aligned with the center of the two adjacent discharge ports 18 in the other row, so that the discharge ports 18 form a staggered pattern in the arrangement direction as a whole, it is possible to narrow the port layout pitch of the entire discharge ports 18 in the two rows by reducing the diameter of discharge ports 18 sufficiently but without narrowing the port layout pitch P too much, thus to make the liquid pools laid out on the substrate W extremely close to each other, thus resulting in forming a treatment liquid film with a uniform film thickness on the substrate W. It should be noted that the resultant overall port layout pitch is P/2 when the port layout pitch of each row is P.

The diameter “d” of each discharge port 18 for forming a treatment liquid film with a uniform film thickness on the substrate W with a minimum amount of the treatment liquid should be larger than 0.35 mm and smaller than 5 mm, while the port layout pitch P of each row should be larger than 1 mm and smaller than 10 mm.

When the entire top surface of the substrate W is covered with the treatment liquid as described above, the supply of the treatment liquid from treatment liquid supply device 37 is stopped. When this occurs, the weight of the treatment liquid filling liquid retaining chamber 22 does not affect the treatment liquid in liquid retaining chamber 16 as the top edge of liquid supply chamber 16 is situated above the top edge of liquid retaining chamber 22, thus the treatment liquid in each liquid retaining chamber 16 and vertical hole 17 remain in the particular liquid retaining chamber 16 and vertical hole 17. By the action described above, the liquid dripping from said discharge port 18 is prevented that might otherwise occur when the supply of the treatment liquid is stopped, thus preventing the unevenness of the film thickness of the treatment liquid from being formed on the substrate W.

The same process is repeated on each substrate W that is transported one after the other, and a desired treatment film is formed on each substrate W.

The above is only an exemplifying embodiment of the invention and the specific mode of the embodiment of the present invention is not limited to it. For example, although two rows of discharge ports 18 and vertical holes 17 are arranged in the above example, they can be arranged in three or more rows. However, it is essential that discharge ports 18 on each row are aligned between the adjacent discharge ports 18 of the adjacent row(s), so that discharge ports 18 are arranged in a staggered fashion in the direction of the row.

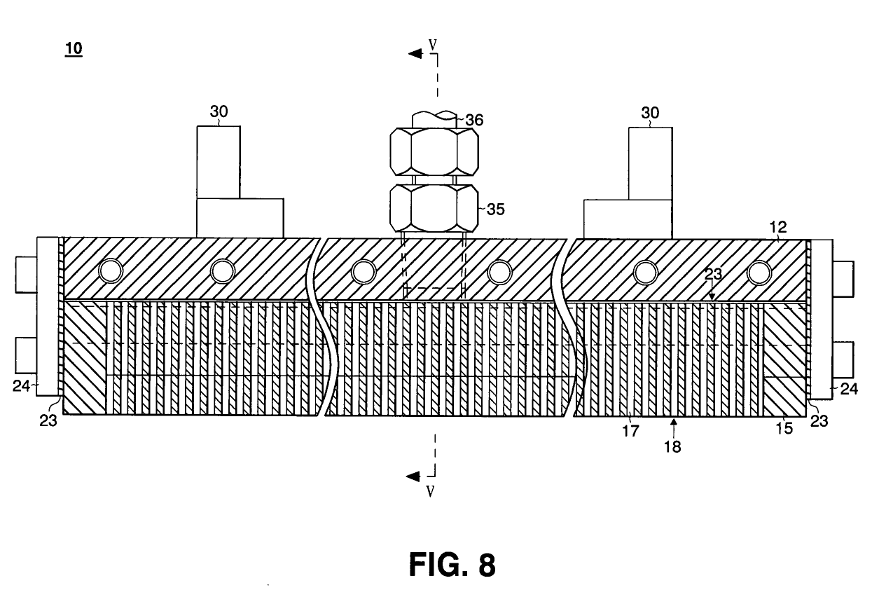

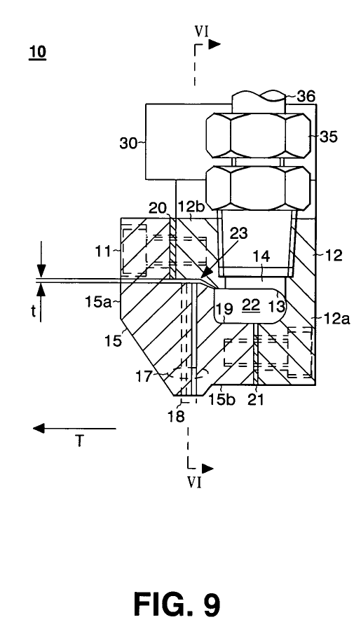

Moreover, although a groove-like liquid supply chamber 16 is provided and vertical holes 17 are provided to open at the bottom of liquid supply chamber 16, it is also possible not to have a liquid supply chamber 16 but to have vertical holes 17 to open on the top surface of horizontal side 15b of second member 15 to access communication path 23 directly as shown in FIG. 8 and FIG. 9. Such an arrangement provides the same effect as substrate treatment device 1 does.

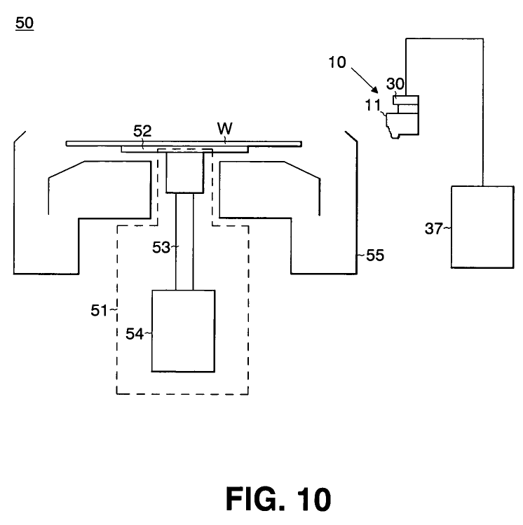

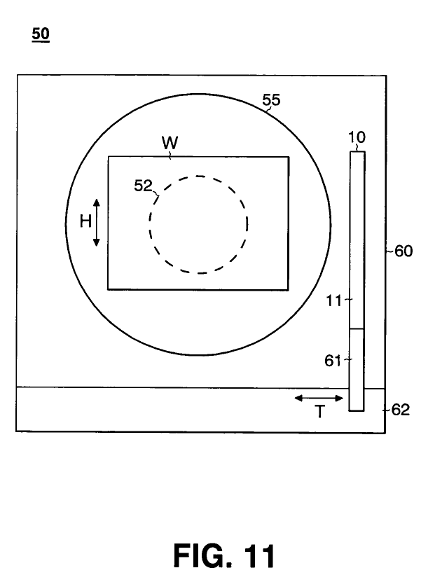

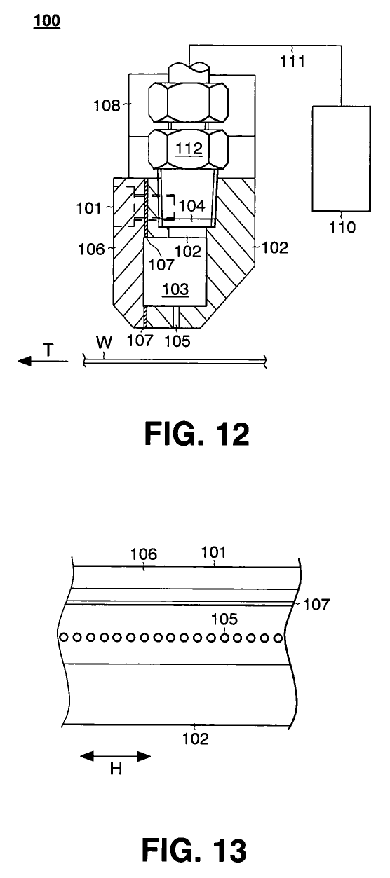

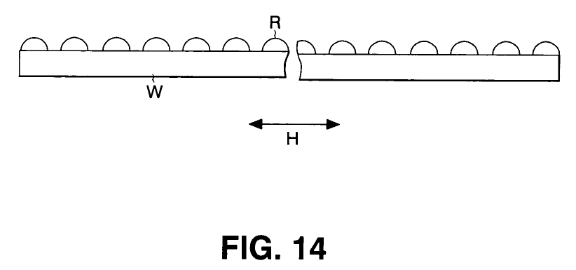

The substrate treatment device according to this invention can be arranged as shown in FIG. 10 and FIG. 11 as well. The process of coating the substrate W with the treatment liquid in this case will be a sheet-fed process, not a continuous process. As shown in FIG. 10 and FIG. 11, a substrate treatment device 50 in this case comprises a support/turning device 51 that supports the substrate W horizontally and turns it horizontally, nozzle device 10 shown in FIG. 3 and FIG. 5, nozzle device 10 shown in FIG. 8 and FIG. 9, a treatment liquid supply device 37 that supplies the treatment liquid to nozzle device 10, and a transport device 60 that supports and transports nozzle device 10 along the substrate W.

Support/turn device 51 comprises a spin chuck 52 for holding the substrate W by vacuum, a turning shaft 53 for supporting spin chuck 52, and a drive mechanism 54 for turning rotating shaft 53 about its axis, wherein rotating shaft 53 and spin chuck 52 turns driven by drive mechanism 54, thus causing the substrate W supported by spin chuck 52 to turn horizontally. Drive mechanism 54 has an indexing function to index rotating shaft 53 at a specified angle in its turning direction, and spin chuck 52 is indexed to a predetermined rotational angle position after the turning. The substrate W is placed on spin chuck 52 thus indexed in a posture shown in FIG. 11, and the substrate W is then suctioned to and supported by spin chuck 52. A cover 55 shown in the drawing covers the surrounding of the substrate W.

Transport device 60 comprises a support arm 61 that supports nozzle device 10 in such a manner that its longitudinal direction aligns with the width direction (direction indicated by arrow H) of the substrate W, and a transport mechanism 62 that transports support arm 61 in a direction T′, which is perpendicular to said width direction (direction indicated by arrow H).

Thus, according to this substrate treatment device 50, the substrate W is first mounted on spin chuck 52 and then nozzle device 10 is transported by means of transport device 60 in a direction of approaching the substrate W while it is suctioned to and supported by spin chuck 52. Simultaneously, the pressurized treatment liquid is supplied to nozzle device 10 from treatment liquid supply device 37, and the treatment liquid flows down from discharge ports 18 to be coated on the substrate W. After the entire surface of the substrate W is coated with the treatment liquid, nozzle device 10 returns to the original position.

When nozzle device 10 returns to its original position, the substrate W is turned for a specified time by drive mechanism 54. This causes the treatment liquid coated on the substrate W to spread out thinner by means of centrifugal force, making the thickness of the treatment liquid coated on the substrate W further uniform. The substrate W is then stopped to complete a series of process.

The present invention can be applied to various substrates including liquid crystal glass substrates, semiconductor wafers (silicon wafers), photomask glass substrates, and optical disk substrates. Moreover, there is no particular restriction to the treatment liquid to which this invention can be applied and the applicable treatment liquids include various treatment liquids used in the manufacturing process of semiconductors and liquid crystals such as developing liquid, resist liquid, resist removing liquid, etching liquid, and washing liquids (pure water, ozone water, hydrogen water, electrolytic water, etc.) The nozzle device and the substrate treatment device equipped therewith is applicable to uniformly coating various substrates including liquid crystal glass substrates, semiconductor wafers, photomask glass substrates, and optical disk substrates with treatment liquids including chemicals and washing liquids.

Hence obvious changes may be made in the specific embodiment of the invention described herein, such modifications being within the spirit and scope of the invention claimed, it is indicated that all matter contained herein is intended as an illustrative and not as limiting in scope.

What is claimed is:

1. A nozzle device having a long nozzle body for discharging treatment liquid to coat an object, wherein
said nozzle body comprises:
a plurality of discharge ports formed on its bottom surface;
a liquid retaining chamber for retaining supplied treatment liquid; and
a liquid discharge flow path which communicates with said discharge ports on one end and with said liquid retaining chamber on another end, causing the treatment liquid retained in said liquid retaining chamber to flow to said discharge ports and to discharge from said discharge ports,
wherein said discharge ports are arranged in two rows along a longitudinal direction of said nozzle body with said discharge ports of one row being staggered with respect to said discharge ports of the other row, thus forming a staggered pattern in the longitudinal direction.

2. A nozzle device of claim 1, wherein
said liquid retaining chamber and said liquid discharge flow path are arranged parallel along said longitudinal direction, and a top edge of said liquid discharge flow path is situated above a top edge of said liquid retaining chamber; and
the top edge of said liquid retaining chamber communicates with the top edge of said liquid discharge flow path through a communication path.

3. A nozzle device of claim 2, wherein
said liquid discharge path comprises a plurality of vertical holes that communicate with said discharge ports respectively and a top edge of each vertical hole communicates with the top edge of said liquid retaining chamber through said communication path.

4. A nozzle device of claim 3, wherein
said liquid discharge path comprises a plurality of vertical holes that communicate with said discharge ports individually and a liquid supply chamber formed above said vertical holes in such a way that a bottom edge of said chamber communicate with the top edge of said vertical holes, wherein the top edge of said liquid supply chamber communicates with the top edge of said liquid retaining chamber with said communicating path.

5. A nozzle device of claim 1, wherein
a diameter of said discharge port is larger than 0.35 mm and less than 5 mm, and the port layout pitch of each row is larger than 1 mm and less than 10 mm.

6. A substrate treatment device comprising:
a support means for supporting a substrate;
a nozzle device of claim 1, which is provided above the substrate supported by said supporting means for discharging treatment liquid on said substrate;
a treatment liquid supply means for supplying pressurized treatment liquid to said nozzle device, and
a transport means for transporting said nozzle body and the substrate supported by said supporting means relative to each other in a direction perpendicular to a longitudinal direction of the nozzle body.

7. A substrate treatment device of claim 6, wherein
said supporting means and transport means comprise a plurality of rollers for supporting said substrate and a roller transport device for linearly transporting said substrate by means of roller rotations s.

8. A substrate treatment device of claim 6, wherein
said supporting means comprises a carriage for supporting the substrate, and
said transport means comprises a transport device that linearly transport said nozzle body in a direction perpendicular to a longitudinal direction linearly along said substrate.

9. A substrate treatment device of claim 8 further comprising:
a turning drive device for turning said carriage horizontally.

10. A nozzle device of claim 1, wherein the discharge ports of each row are disposed with a port layout pitch of P, and the discharge ports of one row is displaced with respect to the discharge ports of the other row in the longitudinal direction by ½ P.

11. A nozzle device of claim 10, wherein the port layout pitch P is between 1 mnm to 10 mm.

12. A nozzle device of claim 10, wherein a diameter of each discharge port is between 0.35 mm to 5 mm.

13. A nozzle device of claim 1, wherein the discharge ports of each row are disposed with a port layout pitch of P, each discharge port has a diameter d, and the port layout pitch P is less than or equal to twice the diameter d.

14. A nozzle device of claim 13, wherein the discharge ports of one row is displaced with respect to the discharge ports of the other row in the longitudinal direction by ½ P.
